(19) United States
(12) Patent Application Publication
(10) Pub. No.: US 2025/0196475 A1
(43) Pub. Date: Jun. 19, 2025

(54) FIRE RESISTANT BUILDING BOARD

(71) Applicant: CERTAINTEED GYPSUM, INC., Malvern, PA (US)

(72) Inventors: Robin FISHER, Loughborough (GB); Remi LESPIAT, Devon, PA (US); Corinne SALLES, Caumont Sur Durance (FR); Jan RIDEOUT, Rothley (GB); Julie GODEFROID, Malvern, PA (US)

(21) Appl. No.: 18/979,988

(22) Filed: Dec. 13, 2024

Related U.S. Application Data
(60) Provisional application No. 63/610,454, filed on Dec. 15, 2023.

(30) Foreign Application Priority Data
Jan. 11, 2024 (EP) 24305076.2

(51) Int. Cl. B32B 19/04; E04B 1/76

(52) U.S. Cl. CPC B32B 19/046; E04B 1/7608; B32B 2250/05; B32B 2307/3065; B32B 2307/7376; B32B 2419/00

(57) ABSTRACT

A building board, particularly a gypsum board, can include a first cover sheet, a second cover sheet, a first layer with gypsum disposed between the first and second cover sheets, a second layer with gypsum disposed between the first cover sheet and the first layer, and an interlayer between the first and second sheets. The board can have a TC4 failure time—the time to reach 140° plus room temperature on the cold face of the board—of greater than 73 minutes. The board can have a TC4 failure improvement time—the amount of time longer the board lasted in a TC4 failure time test compared to the standard board—of at least about 3 minutes or TC4 failure improvement percentage time of at least 1.5%. The board can have at least 15% expansion improvement-a percentage the board expanded over expansion of a standard board-over a standard board.

### FIELD OF THE DISCLOSURE

The present disclosure relates to a fire resistant building board.

### BACKGROUND

Building board, also known as wallboard, plasterboard, or drywall, is one of the most commonly used building components in the world. Building board is frequently used within the interior of a dwelling, where it functions both as a finished wall covering and as a structural room partition. Building board can also be used on the exterior of a dwelling, where it serves as a sheathing to provide weather protection and insulation. Building board can also be used as an interior facing for other structures as well, such as stairwells, elevator shafts, and interior ducting.

One particularly popular form of building board is known as gypsum board. Gypsum board is constructed by depositing a layer of cementitious gypsum slurry that may contain certain fillers and polymeric additives between two opposing liners, which can be paper, glass fiber mats, or paper supported by glass fiber mats, whereby the glass fiber mats can be partly embedded into the gypsum core.

Most gypsum boards are designed for interior use benefiting from the natural fire resistant property of gypsum. Exposure to high temperature flames or gases can cause portions of the gypsum to release water from the gypsum dihydrate crystals of the core. While the release of water from the dihydrate may function to suppress heat transmission within a panel for some time, shrinkage within the panel can allow heat to reach underlying structures.

There exists a need in the art for improved building board composites, particularly gypsum board composites. More specifically, there is a need in the art for cost-effective building boards which provide enhanced durability and fire resistance.

### SUMMARY

According to one embodiment, a building board is disclosed. The building board can include a first cover sheet, a second cover sheet, a first layer, a second layer, and an interlayer. The first layer can include gypsum. The first layer can be disposed between the first and second cover sheets. The second layer can include gypsum and be disposed between the first cover sheet and the first layer. The interlayer can be between the first sheet and the second sheet. The building board can have a TC4 failure time of greater than 73 minutes.

According to a further embodiment, a building board is disclosed. The building board can include a first cover sheet, a second cover sheet, a first layer, a second layer, and an interlayer. The first layer can include gypsum. The first layer can be disposed between the first and second cover sheets. The second layer can include gypsum and be disposed between the first cover sheet and the first layer. The interlayer can include an intumescent material.

According to a further embodiment, a building board is disclosed. The building board comprises: a first cover sheet; a second cover sheet; a first layer comprises gypsum disposed between the first and second cover sheets; a second layer comprises gypsum disposed between the first cover sheet and the first layer; and an interlayer between the first sheet and the second sheet, wherein the building board has one or more of the following features: the building board has a TC4 failure time of greater than 73 minutes; and/or the thickness of the building board expands at least 1% when exposed to a temperature of at least 200° C.; and/or the interlayer comprises a first expandable intumescent and a second intumescent material different from the first intumescent material, and wherein a weight ratio of the first intumescent material to the second intumescent material is from about 10:90 to about 70:30.

According to a further embodiment, a building board is disclosed. The building board comprises: a first cover sheet; a second cover sheet; a first layer comprises gypsum disposed between the first and second cover sheets; a second layer comprises gypsum disposed between the first cover sheet and the first layer; and an interlayer between the first sheet and the second sheet, wherein the building board has one or more of the following features:
a TC4 failure time of greater than 73 minutes, wherein the TC4 failure time is the amount of time it took to reach 140° plus room temperature on the cold face (TC4) of the building board;
a TC4 failure improvement time of at least about 3 minutes, wherein the TC4 failure improvement time is equal to the amount of time longer that the building board lasted in a TC4 failure time test as compared to the amount of time that a standard board without an intumescent layer lasted;
a TC4 failure improvement percentage time of at least 1.5%, wherein the TC4 failure improvement percentage time is equal to the percentage of time longer that the building board lasted in a TC4 failure time test as compared to the percentage of time that a standard board without an intumescent layer lasted;
at least a 15% expansion improvement over a standard board, wherein the expansion improvement is equal to the percentage the building board expanded over an amount of expansion of the standard board tested during the TC4 failure test;
the thickness of the building board expands by at least 1% when exposed to a temperature of at least 200° C.; or
the interlayer comprises a first intumescent material and a second intumescent material different from the first intumescent material, a weight ratio of the first intumescent material to the second intumescent material being from about 10:90 to about 70:30.

According to a further embodiment, a method of making a building board is disclosed, in particular a method for making a building board as defined herein. Such method can include: forming a first layer including gypsum; dispersing an intumescent material over the first layer to form an interlayer; and rolling the first layer and formed interlayer between two cover sheets to form a building board.

### BRIEF DESCRIPTION OF THE DRAWINGS

The present disclosure may be better understood, and its numerous features and advantages made apparent to those skilled in the art by referencing the accompanying drawings.

FIGS. 1A-1B each include an illustration of a cross-section of a building board composite, according to one embodiment.

FIGS. 2A-2B each include an illustration of a cross-section of a building board composite, according to one embodiment.

FIG. 3 includes an illustration of a method of producing a building board, according to one embodiment.

FIG. 4 includes a schematic set-up for the small-scale partition test.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present disclosure relates to a building board with improved heat resistance. The building board includes a core and interlayer that are both disposed between two cover sheets. Particularly the composite board has a thermal insulation failure time not previously seen.

The building board of the present disclosure may be suitable for interior use. In embodiments, the building board can be a wallboard, a dry wall, a gypsum board, a gypsum lathe, a gypsum panel or a gypsum sheathing.

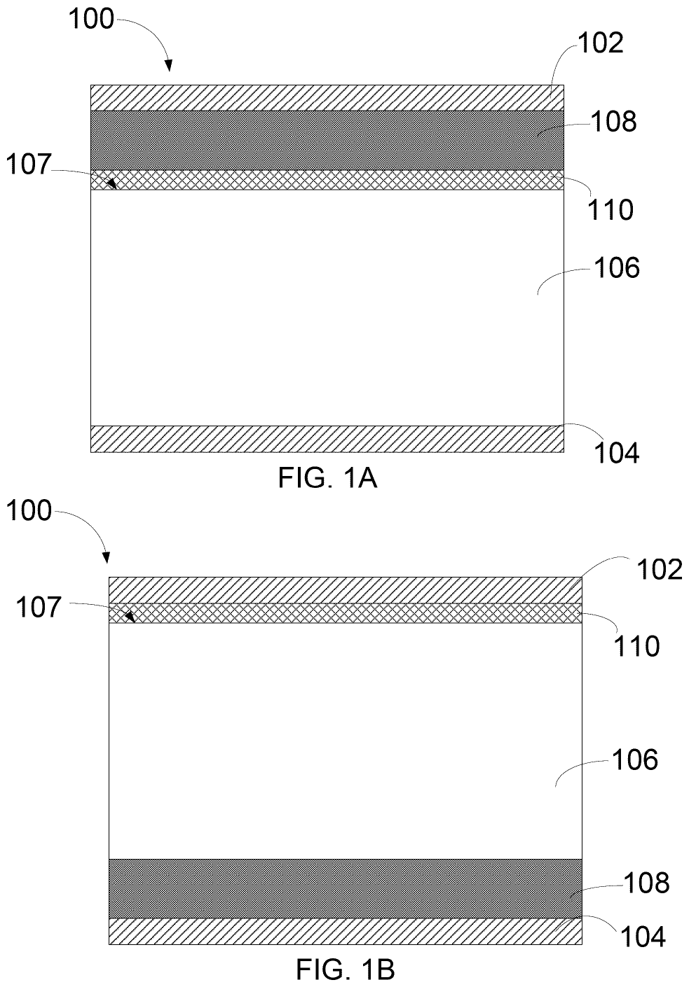

FIG. 1A illustrates a building board composite, according to one embodiment. Building board is typically formed in long sheets in a continuous production line process. The sheets are thereafter cut to a desired length. Boards are produced in standardized widths of either 4 or 9 feet, depending upon the intended use. However, the present invention is by no means limited to any specific board dimensions or geometry. The building board 100 may contain a first cover sheet 104, a second cover sheet 102, a first layer 106, a second layer 108, and an interlayer 110.

The first layer 106 may be between the first cover sheet 104 and the second cover sheet 102. The first layer 106 may be known as a core. In one embodiment, the first layer 106 may be made from a gypsum slurry. Gypsum slurry is the semi-hydrous form of calcium sulfate and has many physical characteristics that make it suitable for use as a building component. The slurry that forms the first layer 106 may comprise a material selected from the group consisting of calcium sulfate alpha hemihydrate, calcium sulfate anhydrite, calcium sulfate dihydrate, and calcium sulfate beta hemihydrate. The amount of gypsum in first layer 106 can comprise at least about 60 wt. % of set gypsum, such as at least 65 wt. %, at least 70 wt. %, at least 75 wt. %, at least 80 wt. %, at least 85 wt. %, at least 90 wt. %, at least 95 wt. %, or at least 98 wt. % of set gypsum based on the total weight of the layer. In one embodiment, set gypsum is gypsum that has dried, set, and is no longer viscous. The slurry can include one or more additives. The slurry can also include set accelerators, retarders, starch, foaming agents, dispersing agents, mold resistance additive, water resistant additives and fire resistant additives. In one embodiment, polymer additives such as polyvinylidene chloride (PVDC), polyvinyl acetate (PVA), or polyvinylchloride (PVC) can be included in the slurry. In another embodiment, additives such as mineral fillers such as, for example, glass fibers (e.g., chopped glass fibers), basalt fibers and calcium sulfate whisker fibers, vermiculite, clay, colloidal silica and colloidal alumina may be included in the slurry. A fire-resistant material can be included in the first layer and can be generally from about 0.03 wt. % to about 10 wt. %, depending on the type of material that is used. In operation, the fire-resistant material can be dispersed into the slurry mixture as the slurry is being combined. For mineral filler such as clay or vermiculite, the amount can be generally from 2 wt. % to 10 wt. %. Reference weight is the total dry weight of the core material. The amount of glass fibers included in the first layer can be generally from about 0.1% to 1%.

The second layer 108 may be between the first cover sheet 104 and the first layer 106, as seen in FIG. 1B. The second layer 108 may be a denser slurry than the first layer 106. The second layer may have a thickness between 0.04 inches to 0.125 inches. The second layer can also include a fire-resistant material. In operation, the fire-resistant material can be dispersed into the slurry mixture of the second layer 108 as the slurry is being combined. Although FIG. 1A shows the second layer 108 between the second cover sheet 102 and the first layer 106, the second layer 108 can also be formed between the first cover sheet 104 and the first layer 106, as seen in FIG. 1B. In another embodiment, the building board can include a third layer similar to the second layer 108 such that the first layer 106 is between the second layer 108 and the third layer. The second layer 108 can include a polymer additive to increase the overall durability of the building board. Polymer additives may be selected from the group consisting of polyvinylidene chloride (PVDC), or polyvinylchloride (PVC), or similar polymers, functionalized styrene butadiene (SBD) latex, a silane (SiH₄). During one manufacturing method, the second layer 108 can be deposited over the first layer 106.

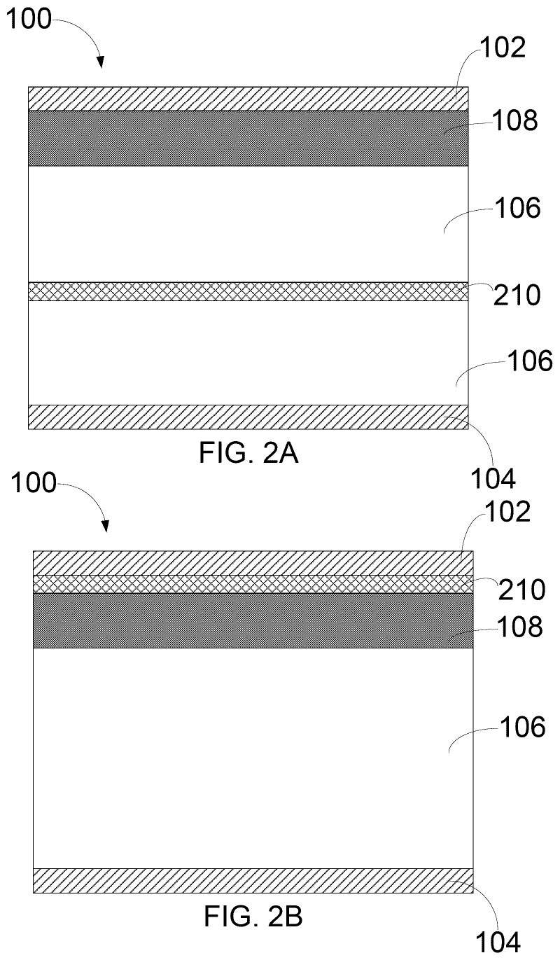

An interlayer 110 can be included in the building board 100. In one embodiment, the interlayer 110 can be between the first layer 106 and the second layer 108, as seen in FIG. 1A. In another embodiment, the interlayer 110 can be between the first cover sheet 104 and the second cover sheet 102. In one embodiment, the interlayer 210 can be between the second cover sheet 102 and the second layer 108, as seen in FIG. 2B. In yet another embodiment, the interlayer 210 can be anywhere within the layers of the building board 100, as seen in FIG. 2A. In one particular embodiment, the interlayer 110 or 210 can be within one of the layers of the building board 100. The interlayer 110 or 210 may have a thickness between 0.01 inches to 1.5 inches. In one embodiment, the interlayer 110 or 210 can have a thickness of no greater than 1.5 inches, such as 1.0 inches, such as 0.5 inches, such as 0.4 inches, or such as 0.3 inches. In one embodiment, the interlayer 110 or 210 can have a thickness of no less than 0.01 inches, such as no less than 0.02 inches, or no less than 0.05 inches. In one embodiment, the interlayer 110 or 210 can have a thickness that is one tenth a thickness of the first layer 106. In another embodiment, the interlayer 110 or 210 can have a thickness that is between one fourth and one twentieth a thickness of the first layer 106.

The interlayer 110 can include an intumescent material selected from the group consisting of expandable graphite, vermiculite, perlite, mica, and a combination thereof. In one embodiment, the interlayer 110 does not include gypsum. In one embodiment, the interlayer 110 can include a ratio of intumescent material to gypsum of between 0:100 and 30:70. In another embodiment, the interlayer 110 can include a ratio of intumescent material to gypsum of between 90:10 and 95:5. In one embodiment, the interlayer 110 can include between 5 wt. % and 98 wt. % of intumescent material. In one embodiment, the interlayer 110 can contain no more than 95 wt. % of intumescent material, such as no more than 90 wt. %, or no more than 80 wt. %, or no more than 75 wt. %. In another embodiment, the interlayer 110 can contain at least 5 wt. % of intumescent material, such as at least 10 wt. %, or such as at least 20 wt. %, or such as at least 40 wt. % of intumescent material. In one embodiment, the interlayer 110 contains more than one intumescent material. In one embodiment, the interlayer 110 can have a weight ratio of a first intumescent material to a second intumescent material from about 10:90 to about 70:30. In one embodiment, the interlayer 110 contains a combination of expandable graphite and expandable vermiculite. In one embodiment, intercalating agents can be included within the interlayer 110 in order to decompose and volatize the intumescent materials to aid in expansion upon heating. The particle size of the intumescent material in the interlayer 110 can be varied. In one embodiment, the interlayer 110 can include materials having a particle size from between 2 mesh to 400 mesh, such as a particle size between 10 mesh and 350 mesh, or such as between 45 mesh to 80 mesh. In one embodiment, the interlayer 110 can include materials having a particle size of no more than 350 mesh, such as 200 mesh, or such as 100 mesh. In another embodiment, the interlayer 110 can include materials having a particle size of no less than 3 mesh, such as 10 mesh, or such as 30 mesh. In one embodiment, the interlayer 110 can contain a first intumescent material, a second intumescent material, and a third intumescent material, where each of the first, second, and third intumescent materials are a blend of intumescent particles of various compositions selected from the group consisting of graphite, vermiculite, perlite, and mica. In one embodiment, the interlayer 110 can contain a first intumescent material, a second intumescent material, and a third intumescent material, where each of the first, second, and third intumescent materials are a blend of intumescent particles of various particle sizes.

In operation, once the first layer 106 has been formed, intumescent material can be scattered on top of the first layer 106 to form the interlayer 110. In another embodiment, the interlayer 110 can be dispersed over the first layer 106 before the first layer 106 has completely solidified. In one embodiment, the interlayer 110 can partly mix with the first layer 106 such that the first layer 106 has a higher concentration of intumescent material than gypsum on one-fourth the thickness of the layer. In other words, the distribution of the intumescent material through the thickness of the first layer 106 is non-uniform and more particularly is concentrated on the top one-fourth of the first layer 106. In another embodiment, the interlayer 110 can intermix with the second layer 108 such that the concentration of intumescent material is located at the bottom one-fourth of the thickness of the second layer 108. In another embodiment, a carrier sheet can be used to hold the intumescent material. The carrier sheet can comprise a fibrous sheet or mesh, cellulosic material, glass or mineral fibers, or be a woven or non-woven sheet or scrim. In one embodiment, the intumescent material is spread over the carrier sheet prior to being deposited over the first layer 106. In another embodiment, the intumescent material is spread over the carrier sheet after the carrier sheet is deposited over the first layer 106. In one embodiment, the intumescent material can be spread or sprayed in a discontinuous fashion over the carrier sheet to form a discontinuous interlayer 110.

In one embodiment, the interlayer 110 is discontinuous. There is a fine balance between adhesion of the interlayer 110 and surrounding layers and the dispersion of the layer. If not balanced correctly, mechanical pressures can cause the layers to separate and thereby cause the building board to fail. In one embodiment, the interlayer 110 has a first area that has a higher concentration of intumescent material than a second area. In one embodiment, the intumescent material can be dispersed as separate discrete regions or islands of material. In one embodiment, the dispersion of the interlayer 110 can be chosen so as not to limit the adhesion between the first layer 106 and the second layer 108. The interlayer 110 can include areas that allow the first layer 106 to contact the second layer 108. In one embodiment, the interlayer 110 covers between 5% and 95% a top surface 107 area of the adjacent layer, such as the first layer 106. In another embodiment, the interlayer 110 covers between 40% and 90% of a top surface area of the adjacent layer, such as the first layer 106. In one embodiment, the interlayer 110 exhibits a volume expansion of at least two times its original volume when exposed to a temperature of at least 200° C. for one hour. Advantageously, since the expandable particles of the interlayer 110 can be on the same plane (for example abutting each other in the x-y axis), as expansion occurs, instead of expanding in all directions, the particles can expand in the z direction. In other words, in one embodiment, the expanding particles of the interlayer 110 can be touching such that expansion occurs in the vertical direction and can be limited or constrained in the horizontal direction. In one embodiment, the interlayer 110 can expand in the z direction by at least 1% after being exposed to temperatures between 200° C. and 400° C., i.e., the thickness of the interlayer 110 increases in the z direction by at least 1%. In another embodiment, the interlayer can expand in the z direction by at least 11%, or by at least 12%, or by at least 15%, or by at least 20% after being exposed to temperatures between 200° C. and 400° C. As the temperature continues to increase, so too can the expansion of the interlayer 110. In one embodiment, the maximum expansion in the z direction of the building board can be at least 11%, or at least 15%, or at least 19% or at least 20%, or at least 22%, or at least 25%, or at least 28%.

After deposition of the first layer 106, the interlayer 110, and second layer 108, a first cover sheet 104 and second cover sheet 102 can be applied. In one embodiment, the first cover sheet 104 and the second cover sheet 102 are the same material. In another embodiment, the first cover sheet 104 and the second cover sheet 102 are different materials. The first cover sheet 104 and the second cover sheet 102 can include a woven or non-woven material of organic or inorganic fibers. In one embodiment, the cover sheet 102 and cover sheet 104 can be glass fiber mats. In another embodiment, the cover sheet 102 and cover sheet 104 may include cellulosic fibers, glass fibers, ceramic fibers, mineral wool, polyester, or a combination thereof. The first cover 102 and the second cover 104 may include individual sheets or multiple sheets. The cover sheet 104 can be embedded completely in the first layer 106. In one embodiment, the cover sheet 104 can be embedded to at least 85% in the first layer 106, such as at least 90%, at least 95%, at least 98%, at least 99%, or at least 99.9% based on the total volume of the fiber-mat.

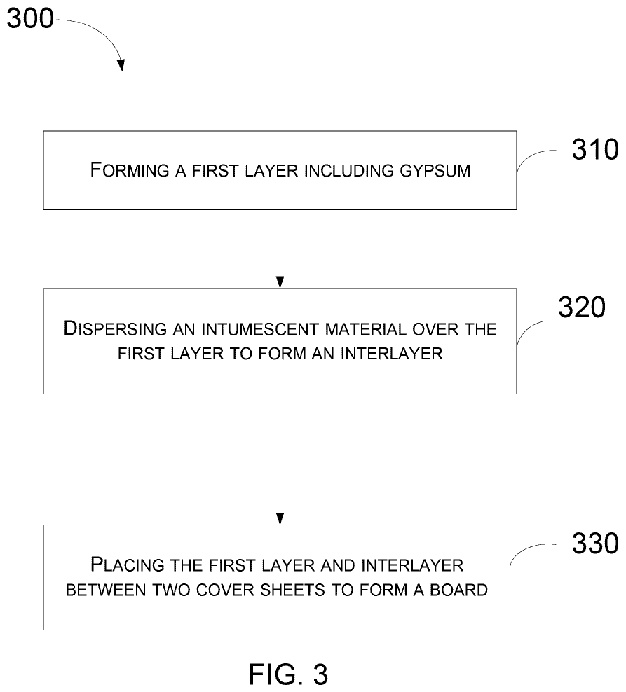

The building board 100 can be included in a wall system or assembly of multiple boards, studs, and supports. The building board 100, as described above, can be manufactured utilizing typical manufacturing lines and in operation utilizing the following steps of the method 300, as seen in FIG. 3. In a mixer, the dry and wet ingredients of a slurry mixture can be combined and agitated. The slurry mixture can be a gypsum slurry mixture. Once thoroughly mixed, the slurry mixture is the precursor to forming the first layer 106. In one embodiment, the slurry mixer can be spread over a first cover sheet 104. In one embodiment, the slurry mixture can be spread over a densified slurry mixture and then solidified. At operation 310, once solidified, the slurry mixture forms the first layer 106.

At operation, 320, the method 300 can continue by spreading an intumescent material over the first layer 106 to form an interlayer 110 before the mixture 106 has fully solidified. In another embodiment, the interlayer 110 can be dispersed over the first layer 106 after the mixture has fully solidified. In yet another embodiment, the intumescent material can be spread over the second layer 108 similarly to the first layer 106. A second densified slurry mixture can then be spread over the interlayer 110 and covered with a second cover sheet 102 to form the building board 100. In one embodiment, the first layer 106, the interlayer 110, and the second layer 108 are rolled between a first cover sheet 104 and a second cover sheet 102 to form the building board 100, at operation 330. In a subsequent step, the building board 100 can be dried to further remove moisture. It should be understood that additional layers, such as skim coats or roller coats, may also be included.

The formed building board can have a TC4 failure time of greater than 73 minutes. TC4 failure time is the time it takes for insulation failure on the cold face (TC4) of the formed building board. Specifically, the TC4 failure time is the amount of time it takes to reach 140° plus room temperature on the cold face (TC4) of the building board. In some embodiments, the building board has one or more (for instance, two or even all) of the following features: the building board have a TC4 failure time of greater than 73 minutes; and/or the thickness of the building board expands at least 1% (for instance by at least 10%, or by at least 12%, or by at least 15%, or by at least 20%) when exposed to a temperature of at least 200° C.; and/or the interlayer comprises a first expandable intumescent and a second intumescent material different from the first intumescent material, and wherein a weight ratio of the first intumescent material to the second intumescent material is from about 10:90 to about 70:30.

In some embodiments, the building board has the following features: the building board has TC4 failure time of greater than 73 minutes; and the thickness of the building board expands at least 1% (for instance by at least 10%, or by at least 12%, or by at least 15%, or by at least 20%) when exposed to a temperature of at least 200° C.

In one embodiment, the building board can have a TC4 failure time of greater than 73 minutes, such as greater than 75 minutes, or such as greater than 80 minutes, or such as greater than 82 minutes. In one embodiment, the TC4 failure time is less than 150 minutes. The building board can have an expansion in the z direction of greater than 1% when exposed to a temperature of 200° C., such as greater than 2%, or greater than 2.5%, or greater than 3%. In one embodiment, the building board can have a maximum expansion in the z direction of at least 10%, for instance greater than 11%, such as greater than 12%, or greater than 15%, or greater than 19% or greater than 35%, or greater than 28%.

In some embodiments, the building board has the following features: the building board has a TC4 failure time of greater than 73 minutes; and the interlayer comprises a first expandable intumescent and a second intumescent material different from the first intumescent material, and wherein a weight ratio of the first intumescent material to the second intumescent material is from about 10:90 to about 70:30.

In some embodiments, the building board has the following features: the thickness of the building board expands at least 1% (for instance by at least 10%, or by at least 12%, or by at least 15%, or by at least 20%) when exposed to a temperature of at least 200° C., and the interlayer comprises a first expandable intumescent and a second intumescent material different from the first intumescent material, and wherein a weight ratio of the first intumescent material to the second intumescent material is from about 10:90 to about 70:30.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiments

Embodiment 1. A building board is disclosed. The building board can include a first cover sheet; a second cover sheet; a first layer comprising gypsum disposed between the first and second cover sheets; a second layer comprising gypsum disposed between the first cover sheet and the first layer; and an interlayer between the first cover sheet and the second cover sheet; where the building board has one of the following: a TC4 failure time of greater than 73 minutes, wherein the TC4 failure time is the amount of time it took to reach 140° plus room temperature on the cold face (TC4) of the building board; a TC4 failure improvement time of at least about 3 minutes, wherein the TC4 failure improvement time is equal to the amount of time longer that the building board lasted in a TC4 failure test as compared to the amount of time that a standard board without an intumescent layer lasted; a TC4 failure improvement percentage time of at least 1.5%, wherein the TC4 failure improvement percentage time is equal to the percentage of time longer that the building board lasted in a TC4 failure time test as compared to the percentage of time that a standard board without an intumescent layer lasted; or at least a 15% expansion improvement over a standard board, wherein the expansion improvement is equal to the percentage the building board expanded over an amount of expansion of the standard board tested during the TC4 failure test.

Embodiment 2. The building board of embodiment 1, where the first layer includes a material selected from the group consisting of gypsum, calcium sulfate alpha hemihydrate, calcium sulfate anhydrite, calcium sulfate beta hemihydrate, and calcium sulfate dihydrate, magnesium oxide, magnesium phosphate, or any combination thereof.

Embodiment 3. The building board of embodiment 1 or 2, where the interlayer can include an intumescent material.

Embodiment 4. The building board of any one of embodiments 1 to 3, where the interlayer can include a material selected from the group consisting of expandable graphite, vermiculite, perlite, mica, and a combination thereof.

Embodiment 5. The building board of embodiment 3 or 4, where the intumescent material has a particle size between 2 mesh and 400 mesh, preferably between 10 mesh and 345 mesh, more preferably between 45 mesh and 80 mesh.

Embodiment 6. The building board of any one of embodiments 1 to 5, where the interlayer is discontinuous.

Embodiment 7. The building board of any one of embodiments 1 to 6, where the interlayer can include an intumescent material without gypsum.

Embodiment 8. The building board of any one of embodiments 1 to 7, where the interlayer covers between 5% and 95% a surface area of the first layer.

Embodiment 9. The building board of any one of embodiments 1 to 8, where the interlayer has a thickness between 0.01 inches and 0.5 inches.

Embodiment 10. The building board of any one of embodiments 3 to 9, where the weight % of intumescent material within the interlayer is between 10 wt. % and 95 wt. %.

Embodiment 11. The building board of any one of embodiments 3 to 10, where the interlayer can include a ratio of intumescent material to gypsum of between 0:100 and 10:90.

Embodiment 12. The building board of any one of embodiments 1 to 11, where the interlayer expands at least 10%, or even at least 11% in the z direction.

Embodiment 13. A building board is disclosed. The building board can include a first cover sheet, a second cover sheet, a first layer can include gypsum disposed between the first and second cover sheets, a second layer can include gypsum disposed between the first cover sheet and the first layer, and an interlayer between the first cover sheet and the second cover sheet, where the thickness of the building board expands at least 1% when exposed to a temperature of at least 200° C.

Embodiment 14. The building board of embodiment 13, where the first layer includes a material selected from the group consisting of gypsum, calcium sulfate alpha hemihydrate, calcium sulfate anhydrite, calcium sulfate beta hemihydrate, and calcium sulfate dihydrate, magnesium oxide, magnesium phosphate, or any combination thereof.

Embodiment 15. The building board of embodiment 13, where the interlayer can include an intumescent material.

Embodiment 16. The building board of embodiment 13, where the interlayer can include a material selected from the group consisting of expandable graphite, vermiculite, perlite, mica, and a combination thereof.

Embodiment 17. The building board of embodiment 15 or 16, where the intumescent material has a particle size between 2 mesh and 400 mesh, preferably between 10 mesh and 345 mesh, more preferably between 10 mesh and 345 mesh.

Embodiment 18. The building board of any one of embodiments 13 to 17, where the interlayer is discontinuous.

Embodiment 19. The building board of any one of embodiments 15 to 18, where the interlayer can include an intumescent material without gypsum.

Embodiment 20. The building board of any one of embodiments 13 to 19, where the interlayer covers between 5% and 95% a surface area of the first layer.

Embodiment 21. The building board of any one of embodiments 13 to 20, where the interlayer has a thickness between 0.01 inches and 0.5 inches.

Embodiment 22. The building board of any one of embodiments 15 to 21, where the weight % of intumescent material within the interlayer is between 10 wt. % and 95 wt. %.

Embodiment 23. The building board of any one of embodiments 15 to 22, where the interlayer can include a ratio of intumescent material to gypsum of between 0:100 and 10:90.

Embodiment 24. A building board can include a first cover sheet, a second cover sheet, a first layer can include gypsum disposed between the first and second cover sheets, a second layer can include gypsum disposed between the first cover sheet and the first layer; and an interlayer between the first sheet and the second sheet, where the interlayer can include a first intumescent material and a second intumescent material different from the first intumescent material, and where a weight ratio of the first intumescent material to the second intumescent material is from about 10:90 to about 70:30.

Embodiment 25. The building board of embodiment 24, where the first layer includes a material selected from the group consisting of gypsum, calcium sulfate alpha hemihydrate, calcium sulfate anhydrite, calcium sulfate beta hemihydrate, and calcium sulfate dihydrate, magnesium oxide, magnesium phosphate, or any combination thereof.

Embodiment 26. The building board of embodiment 24, where the second layer can include a third intumescent material.

Embodiment 27. The building board of any one of embodiments 24 to 26, where the first intumescent material can include a material selected from the group consisting of expandable graphite, vermiculite, perlite, mica, and a combination thereof.

Embodiment 28. The building board of any one of embodiments 24 to 27, where the second intumescent material can include a material selected from the group consisting of expandable graphite, vermiculite, perlite, mica, and a combination thereof.

Embodiment 29. The building board of embodiment 27 or 28, where the first intumescent material has a particle size between 2 mesh and 400 mesh.

Embodiment 30. The building board of embodiment 27 or 28, where (a) the first intumescent material has a particle size between 2 mesh and 400 mesh and/or (b) the second intumescent material comprises one or more particles and the one or more particles each have a particle size between 2 mesh and 400 mesh.

Embodiment 31. The building board of any one of embodiments 24 to 30, where the first intumescent material has a first particle size and the second intumescent material has a second particle size, where the first particle size is different from the second particle size.

Embodiment 32. The building board of any one of embodiments 24 to 31, where the first intumescent material has a particle size from 45 mesh to 80 mesh and the second intumescent material has a particle size from 45 mesh to 80 mesh.

Embodiment 33. The building board of any one of embodiments 24 to 32, where the interlayer is discontinuous.

Embodiment 34. The building board of any one of embodiments 24 to 33, where the interlayer can include a first and second intumescent material without gypsum.

Embodiment 35. The building board of any one of embodiments 24 to 34, where the interlayer covers between 5% and 95% a surface area of the first layer.

Embodiment 36. The building board of any one of embodiments 24 to 35, where the interlayer has a thickness between 0.01 inches and 0.5 inches.

Embodiment 37. The building board of any one of embodiments 24 to 36, where the combined weight % of the first and second intumescent materials within the interlayer is between 10 wt. % and 95 wt. %.

Embodiment 38. The building board of any one of embodiments 24 to 37, where the interlayer can include a ratio of a combined first and second intumescent material to gypsum of between 0:100 and 10:90.

Embodiment 39. A method of making a building board (preferably as defined in any one of embodiments 1 to 37) that can include: forming a first layer including gypsum; dispersing an intumescent material over the first layer to form an interlayer; and rolling the first layer and formed interlayer between two cover sheets to form a building board.

Embodiment 40. The method of embodiment 39, where the intumescent material is dispersed over the first layer before the first layer has fully solidified.

Embodiment 41. The method of embodiment 39, where the intumescent material is dispersed over the first layer after the first layer has fully solidified.

Embodiment 42. The method of any one of embodiments 39 to 41, where the first layer includes a material selected from the group consisting of gypsum, calcium sulfate alpha hemihydrate, calcium sulfate anhydrite, calcium sulfate beta hemihydrate, and calcium sulfate dihydrate, magnesium oxide, magnesium phosphate, or any combination thereof.

Embodiment 43. The method of any one of embodiments 39 to 42, where the interlayer can include one or more intumescent materials.

Embodiment 44. The method of any one of embodiments 39 to 43, where the interlayer can include a material selected from the group consisting of expandable graphite, vermiculite, perlite, mica, and a combination thereof.

Embodiment 45. The method of any one of embodiments 43 or 44, where the intumescent material has a particle size between 2 mesh and 400 mesh.

Embodiment 46. The method of any one of embodiments 39 to 45, where the interlayer is discontinuous.

Embodiment 47. The method of any one of embodiments 39 to 46, where the interlayer can be disposed over a carrier sheet.

Embodiment 48. The method of any one of embodiments 39 to 47, where the interlayer can include an intumescent material without gypsum.

Embodiment 49. The method of any one of embodiments 39 to 48, where the interlayer covers between 5% and 95% a surface area of the first layer.

Embodiment 50. The method of any one of embodiments 39 to 49, where the interlayer has a thickness between 0.01 inches and 0.5 inches.

Embodiment 51. The method of any one of embodiments 39 to 50, where the weight % of intumescent material within the interlayer is between 10 wt. % and 95 wt. %.

Embodiment 52. The method of any one of embodiments 39 to 51, where the interlayer can include a ratio of intumescent material to gypsum of between 0:100 and 10:90.

Embodiment 53. The building board of any one of embodiments 13 to 23, wherein the building board has a TC4 of greater than 73 minutes.

Embodiment 54. The method of any one of embodiments 39 to 51, where said method can include: forming a first layer; dispersing an intumescent material over the first layer to form an interlayer; forming a second layer over the interlayer, and rolling the first layer, formed interlayer, and second layer, between two cover sheets to form a building board.

Embodiment 55. The building board of any one of embodiments 1 to 38, wherein the building board has an integrity on a Tc1 side of at least 3.

Embodiment 56. The method of any one of embodiments 39 to 54, wherein the building board has an integrity on a Tc1 side of at least 3.

### Examples

The following non-limiting examples illustrate the present invention.

Samples 1-6 were tested to determine the percentage of expansion of the building board after exposure to temperatures ranging from 150° C. to 1070° C. Samples 1, 2, and 3 are each a building board without an interlayer. Samples 4-6 are each building boards with an interlayer as described above.

Each board of samples 1-6 includes a first cover sheet with a 481b/MSF creamface paper liner, a second cover sheet with a 38 lb/MSF brown paper liner, and a first plaster slurry layer (also called a first gypsum layer) and a second plaster slurry layer (also called a second gypsum layer) in between the two liners. The first plaster slurry layer for each of the samples includes a mixture of 0.05% heat resistant accelerator, 1% acid thinned starch, 0.1% ethacryl MN superplasticizer, 0.05 mL drop of Plastretard, 88 g of mixing water and the additional compositions of Samples 1-6 described below. Specifically, Sample 1 includes 104 g DSG plaster, 0 g intumescent particles, and no glass fibers in the first gypsum layer; Sample 2 includes 94 (g) DSG plaster, 10.5 (g) intumescent particles within the first gypsum layer, and 3 mm glass fibers within the first gypsum layer; Sample 3 includes 94 (g) DSG plaster, 10.5 (g) intumescent particles within the first gypsum layer, and no glass fibers within the first gypsum layer; Sample 4 includes 98 (g) DSG plaster and 3 mm glass fibers within the first gypsum layer, and 5.2 (g) intumescent particles within an interlayer; Sample 5 includes 94 (g) DSG plaster and 3 mm glass fibers within the first gypsum layer and, 10.5 (g) intumescent particles within an interlayer; and Sample 6 includes 94 (g) DSG plaster and no glass fibers within the first gypsum layer, and 10.5 (g) intumescent particles within an interlayer. The intumescent particles are a Firecarb TEG-315 commercially available from LKAB. The second plaster slurry layer for each of the samples includes a mixture as outlined below with a foam injection. The mixture includes 840 g DSG plaster, 1.68 g HRA, 8.4 g starch, 2.2 g Johns Manville 12 mm glass fibre, 15.5 g Elkem microsilica, 598.1 g mixing water, 5.6 g Diloflo CA30, and 10 drops Plastretard L. The foam injection parameters include the following: 275 ml/min foam solution flow rate, 2 L/min air flow rate, 120.9 g/L calculated foam density, 0.5% Hyonic PFM 10 foaming agent concentration, and 24.4s foam injection time.

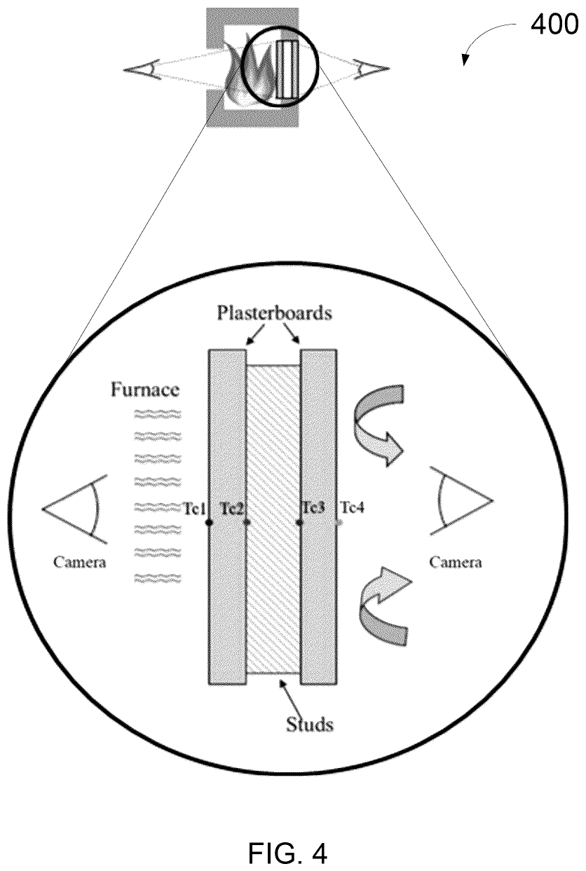

The building boards were evaluated using a small-scale partition test to evaluate the thermal insulation and an expansion/shrinkage of the building board. For testing, a metal frame is built with European a metal studs, Placo Stil® M48 and R48) having a size of 170 mm×142 mm. Two building boards are cut to 147 mm×197 mm. Four thermocouples, Tc K, are fixed in the middle of each side of each board to record the temperatures at each of the four sides: Tc1, Tc2, Tc3, and Tc4, as seen in FIG. 4. FIG. 4 includes a schematic set-up for the small-scale partition test 400. The two building boards are screwed to a metal frame with the screws located 15 mm from the edge of the boards. The building boards are on either side of the metal studs. The boards are places such that the grey side of one board is facing the grey side of the second board and such that the ivory sides are facing outward towards the cameras. Isofrax 1260C boards are added to the surface of the studs (metal frame) between the two boards and used to prevent heat loss. The Isofrax boards are 10 mm thick and 120 LD. A small partition is placed as a false door in an electrical furnace.

The expansion/shrinkage test evaluates expansion in the z direction. A linear displacement transducer placed outside the furnace records the change in dimension of each sample as a 150 mm×30 mm sample of samples 1-6 are each heated for 2 hours at a temperature following the ISO 834 curve. The percentage of board expansion and the time to insulation failure on the cold face (TC4) was recorded for each sample and measured as the time to reach 140° plus room temperature on the cold face TC4. For testing, the furnace is heated such that the furnace temperature follows the ISO 834 curve.

Sample A, a standard building board, in Table 1 below is prepared using the following method. A dense layer and stucco layer are prepared and combined. A dense layer is prepared by placing Perspex sheets onto metal plates, adding wet ivory/pink and brown paper onto the Perspex boards, ensuring the decorative side is facing the Perspex, wiping excess water from the wet paper, placing a roller coat mould onto the paper with an inner mould edge aligned with a top edge of the mould, securing the mould to an edge of a table, mixing water, ethacryl, retarder, and dry mix for 30s to create a dense material, pouring 100 ml of the dense material within mould; spreading from one side to the other the wet mixture of dense across the mould until a smooth even layer is obtained; and removing the mould once the layer is set.

A wet additive is prepared by combining and mixing microsilica and glass fiber at 3600 rpms for 15s. Stucco is added to the wet mixture while mixing for 30s. The stucco mixture is then mixed for 15s at 250 rpm and 3600 rpms for 15s. A foam is added to the stucco mixture and the slurry is left to homogenise for 30s. The slurry is poured over the dense layer and allowed to set. The board is dried at 180° C. for 35 minutes and at 40° C. for 12 hours.

Table 1 shows a summary of measured properties of the building boards.

TABLE 1

| | | | | | TC4 | | | |
|---|---|---|---|---|---|---|---|---|
| | Surface | Average | Expansion | | failure | | Improvement | Integrity of |
| | Density | thickness | in Z at | Max z | time | Improvement | Time | Exposed |
| Sample | (lbs/MSF) | (mm) | 200° C. | expansion | (minutes) | Time (%) | (minutes) | Side Tc1 |
| Sample 1 | 1852 | 16.23 | 0.5% | 0.6% | 71.7 | — | — | 3 |
| Sample 2 | 1802 | 16.20 | 0.4% | 14.1% | 72.7 | 1 | 1.0 | 3 |
| Sample 3 | 1865 | 16.19 | 0.4% | 10.8% | 72.0 | 0 | 0.3 | 3 |
| Sample 4 | 1793 | 15.96 | 1.4% | 19.0% | 74.7 | 4 | 3.0 | 3 |
| Sample 5 | 1877 | 16.26 | 2.1% | 27.1% | 79.3 | 11 | 7.6 | 3 |
| Sample 6 | 1857 | 16.15 | 3.1% | 29.9% | 83.0 | 16 | 11.3 | 3 |

The expansion/shrinkage in thickness test evaluates the z direction dimension during heating because of dehydration, expansion of additives (where applicable) and sintering reactions. As can be seen in table 1, samples 4 to 6 expanded in the z direction by at least 1% after exposure to a temperature of at least 200° C. Samples 4 to 6 had a maximum expansion in the z direction of at least 11% after exposure to heat as compared to the unexposed board. Samples 5 and 6 had a maximum expansion in the z direction of at least 19% after exposure to heat as compared to the unexposed board. Samples 4 to 6 had a TC4 failure time of greater than 72.8 minutes, such as 73 minutes, such as greater than 75 minutes, such as greater than 80 minutes, and such as greater than 82 minutes. Samples 4 to 6 had at least a 15% expansion improvement, such as a 16% expansion improvement, such as a 18% expansion improvement over the standard board seen in sample 1. The expansion improvement is equal to the percentage a building board expanded over an amount of expansion of the standard board tested during the TC4 failure test. Samples 5 to 6 had at least a 19% expansion improvement, such as at least 22%, or at least 24%, or at least 25% expansion improvement over the standard board seen in sample 1. Sample 6 had at least 27% expansion improvement, such as at least 1428%, or such as at least 29% expansion improvement over the standard board seen in sample 1.

The TC4 failure time is the amount of time it takes to reach 140° plus room temperature on the cold face (TC4) of the building board.

Sample 4 had a TC4 failure improvement time of at least about 3 minutes, such as at least about 4 minutes, where the TC4 failure improvement time is equal to the amount of time longer that the building board lasted in a TC4 failure test as compared to the amount of time that a standard board without an intumescent layer, Sample 1, lasted. Sample 5 had a TC4 failure improvement time of at least about 3 minutes, such as at least about 4 minutes, or such as at least about 7 minutes. Sample 6 had a TC4 failure improvement time of at least about 3 minutes, such as at least about 4 minutes, or at least about 11 minutes.

Samples 4, 5, and 6 each had at least a 1.5%, such as at least 3%, or such as at least 4% TC4 failure improvement percentage time over a standard board, Sample 1, where a the TC4 failure improvement percentage time is equal to the percentage of time longer that the building board lasted in a TC4 failure time test as compared to the percentage of time that a standard board without an intumescent layer lasted. Samples 5 and 6 each had at least 5%, or such as at least 6% failure improvement percentage time over a standard board. Sample 6 had at least 128% failure improvement percentage time, such as at least 10% or such as at least 11% failure improvement percentage time.

The integrity of the exposed side, TC1 side, was determined on a scale from 1 to 3, where 1 is determined to be more than 4 fissures and one or more portions of the TC1 side of the board disintegrating or in pieces, 2 is determined to be an intact TC1 side and more than 4 fissures, 3 is determined to be an intact TC1 side and less than 4 fissures. Once the boards were tested, visual integrity is determined according to the above scale. Samples 1 to 6 had an intact TC1 side and less than 4 fissures.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A building board, comprising:
a first cover sheet;
a second cover sheet;
a first layer comprising gypsum disposed between the first and second cover sheets;
a second layer comprising gypsum disposed between the first cover sheet and the first layer; and
an interlayer between the first cover sheet and the second cover sheet, wherein the building board has one or more of the following:
a TC4 failure time of greater than 73 minutes, wherein the TC4 failure time is the amount of time it took to reach 140° plus room temperature on the cold face (TC4) of the building board;
a TC4 failure improvement time of at least about 3 minutes, wherein the TC4 failure improvement time is equal to the amount of time longer that the building board lasted in a TC4 failure time test as compared to the amount of time that a standard board without an intumescent layer lasted;
a TC4 failure improvement percentage time of at least 1.5%, wherein the TC4 failure improvement percentage time is equal to the percentage of time longer that the building board lasted in a TC4 failure time test as compared to the percentage of time that a standard board without an intumescent layer lasted; or
at least a 15% expansion improvement over a standard board, wherein the expansion improvement is equal to the percentage the building board expanded over an amount of expansion of the standard board tested during the TC4 failure test.

2. The building board of claim 1, wherein the first layer includes a material selected from the group consisting of calcium sulfate alpha hemihydrate, calcium sulfate anhydrite, calcium sulfate beta hemihydrate, and calcium sulfate dihydrate, magnesium oxide, magnesium phosphate, or any combination thereof.

3. The building board of claim 1, wherein the interlayer comprises an intumescent material.

4. The building board of claim 1, wherein the interlayer comprises a material selected from the group consisting of expandable graphite, vermiculite, perlite, mica, and a combination thereof.

5. The building board of claim 3, wherein the intumescent material comprises one or more particles and the one or more particles each have a particle size between 10 mesh and 345 mesh.

6. The building board of claim 1, wherein the interlayer is discontinuous.

7. The building board of claim 1, wherein the interlayer comprises an intumescent material without gypsum.

8. The building board of claim 1, wherein the interlayer covers between 5% and 95% a surface area of the first layer.

9. The building board of claim 1, wherein the interlayer has a thickness between 0.01 inches and 0.5 inches.

10. The building board of claim 3, wherein the weight % of intumescent material within the interlayer is between 10 wt. % and 95 wt. %.

11. The building board of claim 3, wherein the interlayer comprises a ratio of intumescent material to gypsum of between 0:100 and 10:90.

12. The building board of claim 1, wherein the interlayer expands at least 10% in the z direction.

13. A building board, comprising:
a first cover sheet;
a second cover sheet;
a first layer comprising gypsum disposed between the first and second cover sheets;
a second layer comprising gypsum disposed between the first cover sheet and the first layer; and
an interlayer between the first cover sheet and the second cover sheet;
wherein the thickness of the building board expands by at least 1% when exposed to a temperature of at least 200° C.

14. The building board of claim 13, wherein the first layer includes a material selected from the group consisting of gypsum, calcium sulfate alpha hemihydrate, calcium sulfate anhydrite, calcium sulfate beta hemihydrate, and calcium sulfate dihydrate, magnesium oxide, magnesium phosphate, or any combination thereof.

15. The building board of claim 13, wherein the interlayer comprises an intumescent material.

16. The building board of claim 13, wherein the interlayer comprises a material selected from the group consisting of expandable graphite, vermiculite, perlite, mica, and a combination thereof.

17. The building board of claim 15, wherein the intumescent material comprises one or more particles and each of the one or more particles have a particle size between 45 mesh and 80 mesh.

18. The building board of claim 13, wherein the interlayer is discontinuous.

19. The building board of claim 13, wherein the interlayer comprises an intumescent material without gypsum.

20. A building board, comprising:
a first cover sheet;
a second cover sheet;
a first layer comprising gypsum disposed between the first and second cover sheets;
a second layer comprising gypsum disposed between the first cover sheet and the first layer; and
an interlayer between the first cover sheet and the second cover sheet, wherein the interlayer comprises a first intumescent material and a second intumescent material different from the first intumescent material, and wherein a weight ratio of the first intumescent material to the second intumescent material is from about 10:90 to about 70:30.
